(19) United States
(12) Patent Application Publication
(10) Pub. No.: US 2019/0062158 A1
(43) Pub. Date: Feb. 28, 2019

(54) DISTRIBUTION OF REACTANT SOLUTION IN A FUEL CARTRIDGE

(71) Applicant: MYFC AB, Stockholm (SE)

(72) Inventors: Michael GLANTZ, Åhus (SE); Björn WESTERHOLM, Saltsjö-duvnäs (SE)

(73) Assignee: MYFC AB, Stockholm (SE)

(21) Appl. No.: 16/068,330

(22) PCT Filed: Dec. 20, 2016
(86) PCT No.: PCT/SE2016/051293

§ 371 Date: Jul. 5, 2018

(30) Foreign Application Priority Data
Jan. 5, 2016 (SE) 1650014-2

(51) Int. Cl. C01B 3/08; B01J 7/02; H01M 8/065; H01M 8/04082

(52) U.S. Cl. CPC C01B 3/08; H01M 8/04208; H01M 8/065; B01J 7/02

(57) ABSTRACT

The invention relates to a fuel cartridge (200) and comprises a reactor compartment (204) housing a reactive material in which an aqueous solution having a pH in the range 12.5 to 14 can be introduced to react with the reactive material to generate hydrogen gas. There is an inlet to said reactor compartment (204) for said aqueous solution and an outlet (216) for hydrogen gas. A porous and hydrophilic film (220) is provided in the reactor compartment at said inlet and having an extension over at least a part of the inner space of the reactor compartment. The film is adapted to convey said aqueous solution by capillary force to distribute the solution over the inside of said reactor chamber.

The film is suitably provided against an inner wall of the reactor compartment and covers at least 50% of the inner wall, preferably the entire inner wall.

The present invention relates to fuel cell technology and in particular to a distribution structure for a reactant solution in a fuel cartridge for providing hydrogen as fuel for fuel cells, and a fuel cartridge.

### BACKGROUND

Fuel cells have attracted more interest over the last few years for many applications, both in automotive technology but also in small scale for the production of electricity. One application is for providing charging of electronic equipment, such as mobile phones, laptop computers etcetera.

In the last few years chemical hydride systems have been developed and been in use for a number of products.

In adsorption hydrogen storage for fueling a fuel cell, molecular hydrogen is associated with the chemical fuel by either physisorption or chemisorption. Chemical hydrides, such as lithium hydride (LiH), lithium aluminum hydride (LiAlH4), lithium borohydride (LiBH4), sodium hydride (NaH), sodium borohydride (NaRH4), and the like, are used to store hydrogen gas non-reversibly. Chemical hydrides produce large amounts of hydrogen gas upon reaction with water as shown below:

NaBH₄+2H₂O-»NaRO₂+4H₂

To reliably control the reaction of chemical hydrides with water to release hydrogen gas from a fuel storage device, a catalyst must be employed along with control of the water's pH. Additionally, the chemical hydride is often embodied in a slurry of inert stabilizing liquid to protect the hydride from early release of its hydrogen gas.

In chemical reaction methods for producing hydrogen for a fuel cell, often hydrogen storage and hydrogen release are catalyzed by a modest change in temperature or pressure of the chemical fuel. One example of this chemical system, which is catalyzed by temperature, is hydrogen generation from ammonia-borane by the following reaction:

NH₃BH₃->NH₂BH₂+H₂->NHBH+H₂

The first reaction releases 6.1 wt. % hydrogen and occurs at approximately 120° C., while the second reaction releases another 6.5 wt. % hydrogen and occurs at approximately 160° C. These chemical reaction methods do not use water as an initiator to produce hydrogen gas, do not require a tight control of the system pH, and often do not require a separate catalyst material. However, these chemical reaction methods are plagued with system control issues often due to the common occurrence of thermal runaway. See, for example, U.S. Pat. No. 7,682,411, for a system designed to thermally initialize hydrogen generation from ammonia-borane and to protect from thermal runaway. See, for example, U.S. Pat. Nos. 7,316,788 and 7,578,992, for chemical reaction methods that employ a catalyst and a solvent to change the thermal hydrogen release conditions.

Another more recent reaction system is using NaSi, as disclosed in i.a. in WO 2015/143212.

In a copending application the present inventors disclose a novel reactant system for use in a fuel cartridge for the production of hydrogen for fuel cell applications. The novel system comprises water, a water soluble first reactant and a second solid reactant in the form of aluminium powder. When contacted with an aqueous solution of the first reactant the aluminium will react and produce hydrogen gas.

In connection with the implementation of this reactant system in a fuel cartridge there is a need for efficient and even distribution of reactant solution over the aluminium powder.

### SUMMARY OF THE INVENTION

The present inventors have therefore devised a novel means for controlled and uniform distribution of a reactant solution over the aluminium powder inside a reactor compartment.

This novel means is provided as a distribution feature of a fuel cartridge, and a novel fuel cartridge comprising this distribution feature is defined in claim 1.

Thus, a fuel cartridge comprises a reactor compartment housing a reactive material in which an aqueous solution having a pH in the range 12.5-14 can be introduced to react with the reactive material to generate hydrogen gas. There is an inlet to said reactor compartment for said aqueous solution and an outlet for hydrogen gas. A porous and hydrophilic film is provided in the reactor compartment at said inlet and having an extension over at least a part of the inner space of the reactor compartment. The film is adapted to convey said aqueous solution by capillary force to distribute the solution over the inside of said reactor chamber.

The film is suitably provided against an inner wall of the reactor compartment and covers at least 50% of the inner wall, preferably the entire inner wall.

Furthermore, there is suitably provided means adapted to mix the components of the reactant system with each other.

In a further aspect a method of distributing reactant solution in a reactor compartment of a fuel cartridge is also provided, and is defined in claim 6.

### BRIEF DESCRIPTION OF THE DRAWINGS

FIG. 1 shows schematically the principle of the novel distribution means in a fuel cartridge; and

FIG. 2 shows schematically an alternative embodiment.

### DETAILED DESCRIPTION

It is well-known that aluminium dissolves in e.g. aqueous sodium hydroxide with the evolution of hydrogen gas, H₂, and the formation of aluminates of the type [Al(OH)₄]—, and the overall reaction can be written as follows:

2Al(s)+2NaOH(aq)+6H₂O→2Na⁺(aq)+2[Al(OH)₄]⁻+3H₂(g)

The bottom line is that when exposed to aqueous solutions under proper conditions the aluminium dissolves and hydrogen gas evolves.

In the mentioned copending application the present inventors optimized the reaction system by selecting proper forms of aluminium and proper composition of the aqueous solution.

In particular it is important to be able to control the hydrogen evolution, both in terms of rate of evolution but also the spatial distribution, in order to fit the application in which the reactant system is to be used. It has been discovered that if the aluminium is provided as a powder having a specified particle size distribution and surface properties it is possible to obtain a very efficient reactant system.

The pH of the aqueous solution should be in the range pH 12.5 to 14.

The reactant system thus comprises the above mentioned aluminum powder, water and a water soluble compound which results in an alkaline solution, in particular a metal hydroxide such as LiOH, NaOH, KOH, Ca(OH)₂ or Mg(OH)₂ would be usable, NaOH being the preferred one.

The Al powder, the water and the water soluble compound are provided in separate compartments in a fuel cartridge, and the method comprises passing water from one compartment to a mixing compartment wherein the water soluble compound is present whereby the water soluble compound dissolves to provide an aqueous solution. The aqueous solution is passed to the reactor, wherein the Al powder is present, such that a reaction takes place and hydrogen evolves, and passing the hydrogen through an outlet to a fuel cell device.

Suitably mechanical means are used for feeding the solution through suitable channels. The mechanical means can be pump means, hydraulic/pneumatic systems or the like.

A fuel cartridge in which the novel distribution feature is to be implemented comprises a reactor a reactor compartment 206 housing a reactive material (preferably Al powder) and in which an aqueous solution having a pH in the range 12.5 to 14 can be introduced to react with the reactive material (Al powder) to generate hydrogen gas. There is also provided an inlet 214 to said reactor compartment 206 for said aqueous solution, and an outlet 216 for hydrogen gas. The gas H₂ is then passed to a fuel cell device FCD via a connection 217

As already mentioned above it is important that the aqueous alkaline solution be uniformly distributed in a controlled manner (temporally as well as spatially) in order to achieve the most efficient hydrogen production.

The novel distribution feature therefore comprises a porous and hydrophilic member 220 provided in the reactor compartment 206 at said inlet 214 and having an extension over at least a part of, preferably over the entire inner space of the reactor compartment 206. The porous and hydrophilic member 220 is adapted to convey said aqueous solution by capillary force within the member 220 to distribute the solution over the inside of said reactor chamber. Suitably the porous member 220 is a film of polyethylene (PE). Such films are available from Nitto under the tradename SUNMAP®.

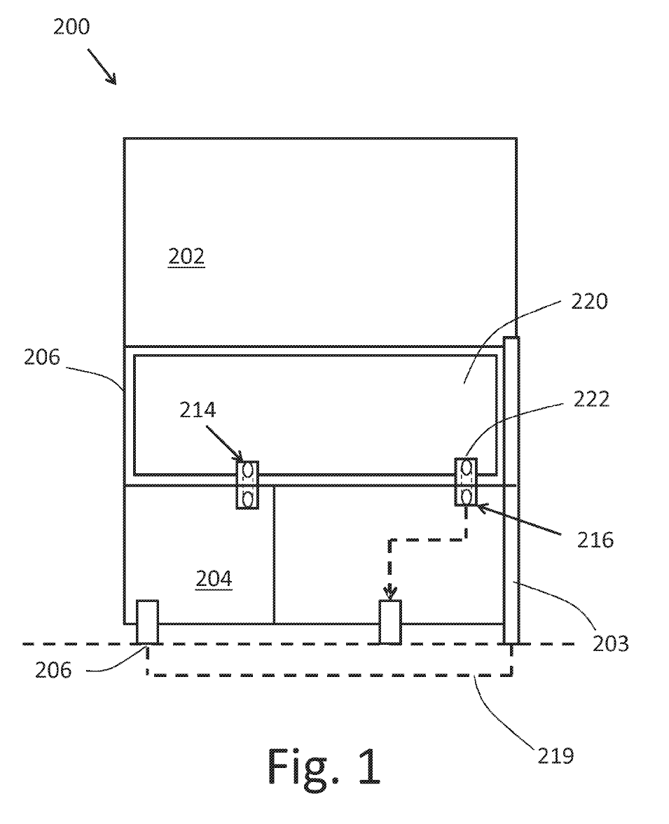

FIG. 1 is a schematic view of the “lid” part of an embodiment of a fuel cartridge 200. In addition to a reactor compartment 206 the fuel cartridge comprises a water compartment 202 having outlet channel 203, and a mixing compartment 204 having inlet 205.

When the cartridge is to be used it will in one embodiment cooperatively engage with a fuel cell device via an interface (not explicitly shown) that provides a water control mechanism for transporting water from the water compartment 202 via channel 203, through a channel system 219 (dashed line) in the interface, via inlet 205 to the mixing compartment 204.

In other embodiments the water control mechanism is integrated in the cartridge which thus forms a self-contained unit, described later.

In the mixing compartment 204 the water will dissolve the water soluble compound housed therein, and the solution thus provided is passed through to the reactor compartment 206 via inlet 214.

In the reactor compartment there is provided a porous and hydrophilic member 220, which in the shown embodiment covers practically the entire inner wall of the lid of the reactor 206. Suitably the member is a film of the material mentioned above. In a preferred embodiment a tab of said film material covers the inlet 214 to act as a filter to prevent unwanted undissolved particles of the water soluble compound to enter the reactor.

Of course it is possible that the film could cover the bottom inner wall of the reactor instead of the inner lid wall. It is merely a matter of design considerations that would render one or the other preferable.

A further aspect of the reactant solution distribution inside the reactor compartment is to ascertain a rapid distribution within the reactive powder. It has been discovered that if small beads of e.g. glass is distributed in the powder a much more efficient spreading occurs, thereby enhancing performance.

These glass beads are preferably spherical and suitably 2.5-2.8 mm in diameter. Suitable beads that have been used in prototypes are obtainable from Preciosa, and are designed and intended for decorative use, e.g. for necklaces.

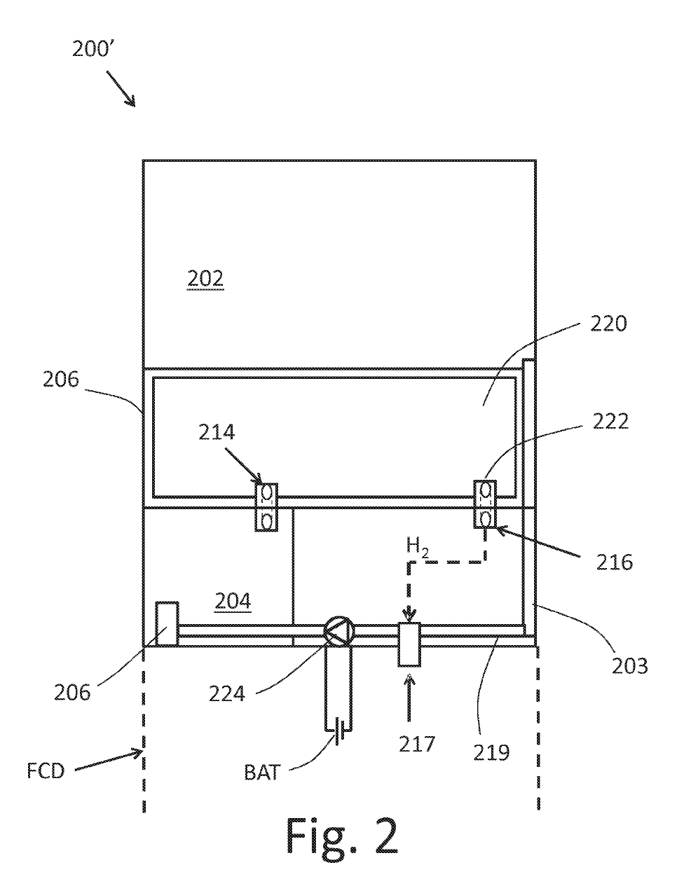

In FIG. 2 a schematic illustration of a self-contained fuel cartridge 200′ is shown. It has essentially the same overall constitution as the embodiment in FIG. 1, but here the water control mechanism, symbolized with a pump 224 provided in the channel system 219, is integrated in the cartridge 200′. The pump can be energized by a suitable electrical connection BAT in the device FCD (schematically shown with dashed lines) to which the cartridge is coupled in use.

All other components remain the same as in the embodiment of FIG. 1.

1. Fuel cartridge (200) comprising a reactor compartment (204) housing a reactive material and in which an aqueous solution having a pH in the range 12.5-14 can be introduced to react with the reactive material to generate hydrogen gas,
characterized by
an inlet (214) to said reactor compartment (204) for said aqueous solution;
an outlet (216) for hydrogen gas; and
a porous and hydrophilic film (220) provided in the reactor compartment (204) at said inlet (214) and having an extension over at least a part of the inner space of the reactor compartment (204), the film adapted to convey said aqueous solution by capillary force to distribute the solution over the inside of said reactor chamber.

2. Fuel cartridge according to claim 1, wherein the film is provided against an inner wall of the reactor compartment (204) and covers at least 50% of the inner wall, preferably the entire inner wall.

3. Fuel cartridge according to claim 1, wherein the reactor compartment is filled with close-packed beads, suitably of glass, where the reactive material occupies the space between said beads.

4. Fuel cartridge according to claim 1, wherein a filter (222) is provided at said outlet.

5. Fuel cartridge according to claim 1, wherein the reactive material is aluminum, preferably in powder form.

6. A method of distributing a reactant solution in a reactor compartment of a fuel cartridge, the reactor compartment comprising a solid first reactant, comprising the steps of:
providing an aqueous solution by dissolving a second reactant in water said second reactant capable of reacting with the first reactant to provide hydrogen gas;
passing said solution into the reactor compartment via a hydrophilic and porous member that has an extension over at least a major part of the reactor compartment and in contact with said solid first reactant.

7. The method according to claim 6, wherein the solid first reactant is aluminium powder, and the second reactant is hydroxide compound, preferably NaOH.

8. The method according to claim 6, wherein the solution is made in a mixing chamber.
